(19) United States
(12) Patent Application Publication
(10) Pub. No.: US 2017/0244791 A1
(43) Pub. Date: Aug. 24, 2017

(54) NETWORK SYSTEM AND METHOD FOR TRANSMITTING DATA IN A NETWORK SYSTEM

(71) Applicant: SIEMENS AKTIENGESELLSCHAFT, Munchen (DE)

(72) Inventor: THOMAS RIPPLINGER, Karlsruhe (DE)

(73) Assignee: SIEMENS AKTIENGESELLSCHAFT, Munchen (DE)

(21) Appl. No.: 15/435,808

(22) Filed: Feb. 17, 2017

(30) Foreign Application Priority Data
Feb. 19, 2016 (EP) 16156564.3

(51) Int. Cl. H04L 29/08; H04L 12/24

(52) U.S. Cl. CPC H04L 67/12; H04L 67/10; H04L 41/046

(57) ABSTRACT

A network system, and a method of use thereof, includes a first network subscriber arranged in an automation network of an automation system, a second network subscriber having a cloud computing infrastructure, and a communication unit for transmitting acquired data from the first network subscriber to the second network subscriber. The communication unit includes a first interface, which is configured as an input/output module and connected to the first network subscriber, and a second interface, which is configured as an agent and connected to the second network subscriber.

### CROSS-REFERENCES TO RELATED APPLICATIONS

This application claims the priority of European Patent Application, Serial No. EP16156564.3, filed Feb. 19, 2016, pursuant to 35 U.S.C. 119(a)-(d), the content of which is incorporated herein by reference in its entirety as if fully set forth herein.

### BACKGROUND OF THE INVENTION

The invention relates in general to a network system and a method for transmitting data between a first network subscriber and a second network subscriber.

The following discussion of related art is provided to assist the reader in understanding the advantages of the invention, and is not to be construed as an admission that this related art is prior art to this invention.

The term “automation system” when used with reference to an industrial plant facility serves in the following to describe devices and installations which are deployed for the purpose of controlling and/or monitoring a technical process, e.g. a manufacturing process, and are known per se. The devices include e.g. programmable logic controllers, decentralized peripheral devices, operator control and monitoring systems or the like, which are connected to one another by way of a data transmission entity, e.g. a LAN network (LAN=Local Area Network), to form a shared automation network. Such devices or networks are referred to collectively as automation components. In the “IoT” (Internet of Things) environment, data is collected and utilized, in order to generate added values by analytical methods. In this context, the processing of the data is carried out on a centralized basis in an external data center or cloud system.

The data is read out from the lower-level automation system, and forwarded over an outgoing connection, for example via the Internet, to the cloud system.

Plant data may be tapped from the automation system or other local devices of an automated plant facility (“IoT data”) by way of fieldbuses. Fieldbus-based systems may be replaced or supplemented in this case by Ethernet-based systems such as Profinet (Process Field Network). This makes a realtime-capable transmission of data possible.

In the prior art, agents are deployed in addition. These are embodied in the form of dedicated software components which collect plant data by using existing interfaces (e.g. OPC, Modbus), and send the data onward to the cloud system.

The automation system may also be extended by a cloud-capable transfer protocol (e.g. ISB Micro Agent protocol).

A drawback of the above-cited systems, however, is that either only limited sampling rates are possible for automation applications (e.g. OPC typically 1 sec) or interventions in existing systems on the plant facility are necessary, e.g. a special engineering solution to enable cloud connectivity. However, the latter is very complex and labor-intensive, and therefore, extremely cost-intensive.

It would therefore be desirable and advantageous to provide an improved network system, and improved method for transmitting data in a network system, to obviate prior art shortcomings and to ensure that a data exchange involving high data throughput/volumes between two network subscribers is possible in a simple and yet reliable manner.

### SUMMARY OF THE INVENTION

According to one aspect of the present invention, a network system includes a first network subscriber arranged in an automation network of an automation system, a second network subscriber having a cloud computing infrastructure, and a communication unit for transmitting acquired data from the first network subscriber to the second network subscriber, the communication unit including a first interface, which is configured as an input/output module and connected to the first network subscriber, and a second interface, which is configured as an agent and connected to the second network subscriber.

According to another aspect of the present invention, a method for transmitting data in a network system includes connecting a first interface of a communication unit to a first network subscriber arranged in an automation network of an automation system, and connecting a second interface of the communication unit to a second network subscriber having a cloud computing infrastructure to enable transmission of data from the first network subscriber to the second network subscriber, configuring the first interface of the communication unit in the form of an input/output module, and configuring the second interface of the communication unit in the form of an agent.

The invention enables high-volume plant data sets to be decoupled for the purpose of further processing in a remote data center (“cloud system”). At the same time, a data reduction or a selection during the transition from the fieldbus to the cloud computing infrastructure is made possible by the invention. Advantageously, in addition a conversion/engineering solution using already available driver modules/equipment is possible. Furthermore, only a minimal amount of extra computational work is added to the CPU load.

The invention enables the automation system to realize extremely high sampling rates, for example, of a few microseconds.

A secure data decoupling is also possible by a defined interface. If necessary, a secure inward coupling can be made from the cloud computing infrastructure to the first network subscriber. In this case, the automated plant facility is also possible, since the data arrives at a defined driver module and consequently no full access to the PLC (programmable logic controller) is possible.

Further advantageous features are set forth in the dependent claims, and may be combined with one another in any desired manner in order to achieve further advantages.

According to another advantageous feature of the present invention, the communication unit can include at least two data transmission modes for transmitting the data, acquired by the first network subscriber, to the second network subscriber. Advantageously, the data of the automation system can be acquired, in particular, acquired continuously, in a first data transmission mode. An aggregation function and/or other compression and preanalysis function may then be applied to the acquired data.

According to another advantageous feature of the invention, the aggregation function can include forming a mean value and/or the minimum or maximum and/or a sum and/or other compression and preanalysis function of data that has been acquired in a predetermined time. The aggregation function/compression and preanalysis function may also include determining a most recently acquired data set of the data that has been acquired in a predetermined time. It is to be understood that the aggregation function or other compression and preanalysis function is not limited hereto.

According to another advantageous feature of the present invention, at least a second data transmission mode may additionally be provided, in which, a data packet for succeeding processing steps is generated from the data acquired by the communication unit, and the data packet can be sent to the cloud.

To sum up, the two data transmission modes enable at least two adjustable conversions of the high data rate e.g. at the field-bus of the first network subscriber into a lower rate for “cloud transfer”, i.e. the data transfer to the second network subscriber.

In this case, a first data transmission mode is provided in the form of a continuous data acquisition and a subsequent calculation of the minimum value/maximum value/mean value/last-sent_data_set every n seconds is performed, where n is configurable, and where the result of the calculation is subsequently sent to the second network subscriber.

In addition, a second data transmission mode is provided, in which the data acquired in a time window is combined to form a data packet, and the resulting data packet is sent to the second network subscriber to undergo further processing there. Advantageously, the data involves source or raw data.

According to another advantageous feature of the present invention, sending of the data packet may be initiated by a trigger, with the trigger being controlled by the first network subscriber. This advantageously enables precise control of the data decoupling by a signal of the application program.

According to another advantageous feature of the present invention, the communication unit can include a sniffer mode. The sniffer mode is configured to rule out a reactive effect on the first network subscriber. This can be realized e.g. by a TAP (terminal access point) connection.

### BRIEF DESCRIPTION OF THE DRAWING

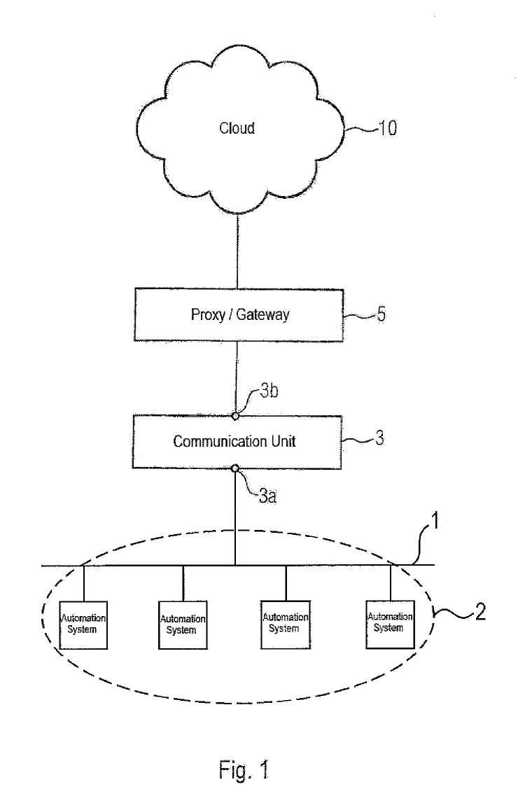

Other features and advantages of the present invention will be more readily apparent upon reading the following description of currently preferred exemplified embodiments of the invention with reference to the accompanying drawing, in which the sole FIG. 1 is a schematic representation of a network system according to the present invention.

### DETAILED DESCRIPTION OF PREFERRED EMBODIMENTS

The depicted embodiment is to be understood as illustrative of the invention and not as limiting in any way. It should also be understood that the FIGURE may not necessarily be to scale. In certain instances, details which are not necessary for an understanding of the present invention or which render other details difficult to perceive may have been omitted.

In automated plant facilities 2 having an automation system, it is necessary to send the plant data collected by sensors or other measurement instruments to a remote data center, known as a cloud 10, for further processing. In existing prior art solutions, either only limited sampling rates of the automation system 1 are possible or complex and labor-intensive interventions in the automation system are necessary. This problem is now being addressed and solved by the present invention.

Turning now to FIG. 1, there is shown a schematic representation of a network system according to the present invention. The network system includes a communication unit 3 having a first interface 3a and a second interface 3b. In this arrangement, the first interface 3a is connected to the automation system 1 of an automated plant facility 2 and the second interface 3b is connected to the cloud 10 for the purpose of transmitting data between the automation system 1 and the cloud 10. In this case, the data acquired from the automation system 1 is transmitted to the cloud 10 by the communication unit 3.

The first interface 3a is embodied in the form of an input/output (I/O) module, i.e. the communication unit 3 behaves toward the automation system like an I/O module, in particular, like a Profinet (Process Field Network) I/O module. All other I/O modules are, of course, also possible. The second interface 3b is embodied in the form of an agent, i.e., the communication unit 3 behaves toward the cloud 10 like an agent.

The communication unit 3 has two different data transmission modes (compression and data sampling). These are adjustable, depending on which application scenario is present. In the first data transmission mode, the data is acquired, and in particular acquired, continuously. An aggregation function and/or a compression and preanalysis function are/is subsequently applied. What is to be understood in this context by an aggregation/compression/preanalysis in connection with the management of large volumes of data is the aggregation of a series of facts to form a single fact.

Aggregation functions (or summing-up functions) and compression and preanalysis functions are those functions which assign a single value to a volume of data sent from the automation system 1 that has been sent in a predetermined time, e.g. every n seconds. The result is then used as representative of the data, i.e. the source data, from the automation system 1.

From an acquired set of values of the automation system 1, the aggregation functions/compression and preanalysis functions can thus determine e.g. the mean value, the minimum or maximum and/or the sum and/or the average. The aggregation function/compression and preanalysis function may also include determining the most recently acquired data set of that data that has been acquired/received in a predetermined time.

Advantageously, at least a second data transmission mode is provided, where a data packet for succeeding processing steps is generated from the data acquired by the communication unit 3, and the data packet can be sent to the cloud 10. Thus, a data packet for succeeding processing steps is generated from the data streams of the automation system 1 that are accumulating substantially continuously and is sent to the cloud 10. The data packet usually involves raw data.

As a result, the source data/raw data can be processed in the cloud 10. The data, i.e. the AO/DO signals (AO=Analog Output, DO=Digital Output) of the automation system 1, is stored/recorded at a given resolution (Profinet resolution) in the communication unit 3 and combined into a data packet. The data packet can in this case be generated according to quite different criteria. The resulting data packet is then sent to the cloud 10, where it is processed further. The decoupled stream signature may be cited here as an example.

Sending of the packet can be started/stopped by a trigger (or trigger signal) (a signal is triggered when a predefined condition is fulfilled or a triggering event occurs). In particular, the trigger signal may be generated by the automation system 1, e.g. via a Profinet DO signal. This enables precise control of the data decoupling by a signal of the application program. However, the trigger may also be fired via the cloud 10, e.g. when a data sampling is required for a detailed diagnosis. A time-controlled transmission, e.g. once per hour, once per day, is likewise possible.

A transfer of raw data to the cloud 10, which can be triggered, is therefore possible.

Advantageously, the communication unit 3 includes a sniffer mode or a sniffer mode that is installed on the communication unit 3. A reactive effect on the automation system 1 is ruled out by the sniffer mode, i.e. no feedback effect on the automated plant facility is possible, because only “read access” is enabled. A LAN analysis is also possible by the sniffer mode. The term “sniffer” relates in this context to the entire generic class of LAN analyzers.

This can be realized e.g. by a TAP connection (TAP=terminal access point).

A further proxy/gateway 5 may additionally be interposed between the communication unit 3 and the cloud 10. This leads to an increase in IT security.

The invention enables a connection to be established between the cloud 10 and the automation system 1, e.g. a Profinet fieldbus, where the problem of data reduction or selection for the transition from the automation system 1 to the cloud 10 is solved. Thanks to the adjustable conversion provided by the invention, the high data rate at the fieldbus can be transformed into a lower rate for cloud transfer.

The invention may be implemented by an engineering solution using standard tools of the existing system, i.e. this presents itself to the existing system as the connection of a standard Profinet I/O module e or some other fieldbus I/O module, e.g. Profibus. Furthermore, the invention represents only a minimal CPU load for e.g. the master in the automation system 1.

Extremely high sampling rates are possible by the invention which may be in the range of a few microseconds.

The cloud 10 and the automation system 1 may in this case be entities that are physically separated from one another at physically different local sites.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A network system, comprising:
a first network subscriber arranged in an automation network of an automation system;
a second network subscriber having a cloud computing infrastructure; and
a communication unit for transmitting acquired data from the first network subscriber to the second network subscriber, said communication unit including a first interface, which is configured as an input/output module and connected to the first network subscriber, and a second interface, which is configured as an agent and connected to the second network subscriber.

2. The network system of claim 1, wherein the communication unit includes at least two data transmission modes for transmitting data, acquired by the first network subscriber, to the second network subscriber.

3. The network system of claim 2, wherein at least one of the data transmission modes is a first data transmission mode for acquiring the data which is subsequently subjected to an aggregation function and/or preanalysis function.

4. The network system of claim 3, wherein the data is acquired continuously.

5. The network system of claim 3, wherein the aggregation function and/or preanalysis function includes forming a mean value and/or a minimum or maximum and/or a sum of the data acquired in a predetermined time.

6. The network system of claim 5, wherein the aggregation function and/or preanalysis function includes determining a most recently acquired dataset of the data acquired in the predetermined time.

7. The network system of claim 2, wherein at least one of the data transmission modes is a second data transmission mode, with the data, acquired by the communication unit, generating a data packet for sending to the cloud computing infrastructure of the second network subscriber.

8. The network system of claim 7, further comprising a trigger configured to send the data packet.

9. The network system of claim 8, wherein the trigger is activated by the first network subscriber.

10. The network system of claim 1, wherein the communication unit includes a sniffer mode.

11. The network system of claim 10, wherein the sniffer mode is configured to rule out a reactive effect on the first network subscriber.

12. The network system of claim 1, wherein the communication unit includes a TAP (terminal access point) connection.

13. The network system of claim 1, wherein the first network subscriber includes a Profinet (Process Field Network) system.

14. A method for transmitting data in a network system, comprising:
connecting a first interface of a communication unit to a first network subscriber arranged in an automation network of an automation system, and connecting a second interface of the communication unit to a second network subscriber having a cloud computing infrastructure to enable transmission of data from the first network subscriber to the second network subscriber;
configuring the first interface of the communication unit in the form of an input/output module; and
configuring the second interface of the communication unit in the form of an agent.

15. The method of claim 14, further comprising providing at least two data transmission modes in the communication unit, and transmitting data acquired by the first network subscriber to the second network subscriber by one of the at least two data transmission modes.

16. The method of claim 15, wherein the at least two data transmission modes are adjustable.

17. The method of claim 15, further comprising continuously acquiring data from at least one of the data transmission modes as a first data transmission mode, and subjecting the data to an aggregation function and/or preanalysis function.

18. The method of claim 15, further comprising configuring at least one of the data transmission modes as a second data transmission mode for acquiring the data, generating a data packet from the acquired data for subsequent processing, and sending the data packet to the cloud computing infrastructure of the second network subscriber.

19. The method of claim 18, wherein the data packet is sent in response to an activation of a trigger by the first network subscriber.

20. The method of claim 14, further comprising executing a sniffer mode on the communication unit.
